(19) United States
(12) Patent Application Publication
(10) Pub. No.: US 2023/0257213 A1
(43) Pub. Date: Aug. 17, 2023

(54) WORKPIECE ROTATION CONTROL SYSTEM ON A PANELING MACHINE AND PANELING MACHINE INCLUDING SUCH SYSTEM

(71) Applicant: Prima Industrie S.P.A., Collegno (IT)

(72) Inventors: Alberto Cavazza, Collegno (IT); Adriano Peruffo, Collegno (IT)

(21) Appl. No.: 18/011,772

(22) PCT Filed: Apr. 22, 2021
(86) PCT No.: PCT/IT2021/050127

§ 371 Date: Dec. 20, 2022

(30) Foreign Application Priority Data
Jul. 1, 2020 (IT) 102020000015850

(51) Int. Cl. B65G 47/90

(52) U.S. Cl. CPC B65G 47/904

(57) ABSTRACT

A workpiece rotation control system on a paneling machine (1) is described, comprising a rotator device (3) and which is served by a manipulator device (5) with a gripper (7) on a rotating axis (9) designed to arrange a workpiece of material to be machined on a rotating element (11) of this rotating device (3), which comprises first measuring means (13) of an angular position of the rotating axis (9) of the gripper (7) and the rotating device which comprises second means for measuring an angular position of the rotating element (11) of the rotating device (3), and processing means provided for comparatively comparing a value of an angular position measured by the first measuring means (13) with at least a value of an angular position measured by the second measuring means. A paneling machine comprising this system is also described.

### CROSS REFERENCE TO RELATED APPLICATIONS

This application is a U.S. National Phase Application filed under 35 U.S.C. § 371 and claims priority to International Application No. PCT/IT2021/050127, filed Apr. 22, 2021, which application claims priority to Italian Application No. 102020000015850, filed Jul. 1, 2020, the disclosures of which are incorporated herein by reference.

### FIELD OF THE INVENTION

The present invention refers to a paneling machine including a workpiece rotation control system.

### BACKGROUND

Machines for paneling pieces, typically sheet metal sheets, are known in the art, usually comprising at least one rotating device and served by at least one manipulator device with gripper on a rotating axis designed to arrange at least one workpiece of material to be processed in a predetermined position on at least one rotating element of this rotating device.

Generally, the rotating element is subject to a motorized rotation commanded by a numerical control (CN), while the gripper presses on the workpiece, for example on the sheet, usually with a force of 40000N: the gripper also includes an idle wheel and is always in contact with the workpiece.

Currently, during the rotation movement of the workpiece (usually above a brush and/or ball plane), and in particular of the sheet metal by the rotator to start the processing by the paneling machine, it may happen that there is a relative movement (rotation) between the rotator and the sheet itself, and this determines an error in the correct positioning reference of the workpiece with respect to the bending line on the rotating element of the rotator device; likewise, there may be a loss of contact between the workpiece and the rotating element of the rotating device, thus generating a relative motion which determines a slippage of the workpiece itself with respect to this rotating element (this rotation can take place after centering and before the first bend of the first side, if the centered side is not the first to be bent, and then always occurs between one side and the next).

To obviate this possible slippage, currently the workpiece is centered again with a consequent increase in the cycle time. This additional centering must be entered into the program manually by the operator in the bending program. The rotation error can occur, for example, when the workpiece is covered with a protective film, or because it is necessary to lower the holding force of the workpiece in order not to damage the surface, so there is less friction effect and during the rotation the workpiece, that is the sheet, could slip; this rotation error can also occur due to the particular inertia of the workpiece as, for example, by adopting too high angular accelerations during its movement, the friction effect of the workpiece is overcome.

At programming level, a formula is therefore used for the automatic calculation of the maximum acceleration to be set to prevent the workpiece from slipping during rotation: this formula, however, does not always work correctly and for very large and heavy pieces, i.e. high inertia, greatly limits the value of the controlled acceleration, with a consequent extra increase in the cycle time.

Consequently, very often it is the operator who, after several attempts, is forced to manually adjust the acceleration value to limit/eliminate slippage or manually add re-centering (i.e. additional centering to the first) of the workpiece in the program to avoid waste material.

The main parameters that therefore affect sliding are:
angular acceleration value set by NC;
type of material of the workpiece (steel, aluminum etc.);
moment of inertia and weight of the workpiece;
value of the force exerted by the gripper (adjustable option);
type of gripper (standard or UBC option)
type of surface of the rotating element (knurled, smooth, bakelite, etc.);
coefficient of friction between workpiece and gripper;
coefficient of friction between the workpiece and the sliding surface, usually with brushes/balls;
surface treatment of the workpiece (protective film, prepainting, galvanizing, etc.).

Documents EP-A1-0 865 331, GB-A-2 004 216, DE-A1-196 41 402 and WO-A1-91/09696 describe control systems according to the prior art.

### SUMMARY OF THE INVENTION

Therefore, object of the present invention is solving the aforesaid prior art problems by providing a paneling machine including a workpiece rotation control system which allows automatically identifying and correcting any relative slippage of this workpiece of material to be processed with respect to the manipulator device.

Another object of the present invention is providing a paneling machine including a workpiece rotation control system which allows having no waste pieces, without increasing (or increasing it to a lesser extent) the cycle time of the required bending operation.

Furthermore, an object of the present invention is providing a paneling machine comprising at least one workpiece rotation control system which allows automatically identifying and correcting any relative slippage of this workpiece of material to be processed with respect to the manipulator device.

The aforementioned and other objects and advantages of the invention, which will emerge from the following description, are achieved with a paneling machine including a workpiece rotation control system as described in claim 1. Preferred embodiments and non-trivial variations of the present invention form the subject of the dependent claims.

It is understood that all attached claims form an integral part of the present description.

It will be immediately obvious that innumerable variations and modifications (for example relating to shape, dimensions, arrangements and parts with equivalent functionality) can be made to what is described without departing from the scope of the invention as appears from the attached claims.

### BRIEF DESCRIPTION OF THE DRAWINGS

The present invention will be better described by some preferred embodiments, provided by way of non-limiting example, with reference to the attached drawings, in which:

FIG. 1 shows a perspective view of a paneling machine and of the relative manipulator device comprising a preferred embodiment of the system according to the present invention;

FIG. 2 shows a transparent view of a component of the manipulator device;

FIG. 3 shows a side sectional view of the detail of the manipulator device enclosed in frame A of FIG. 2;

FIG. 4 shows a perspective view of a component of the system according to the present invention; and

FIG. 5 shows an exemplary scheme for calculating the quantification of any slippage of the workpiece of material to be processed by the paneling machine.

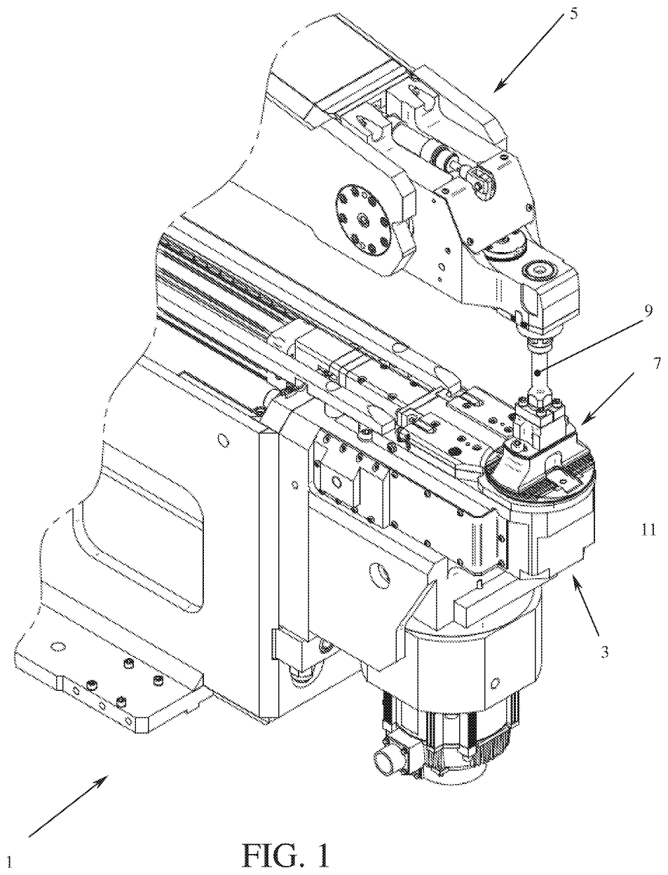

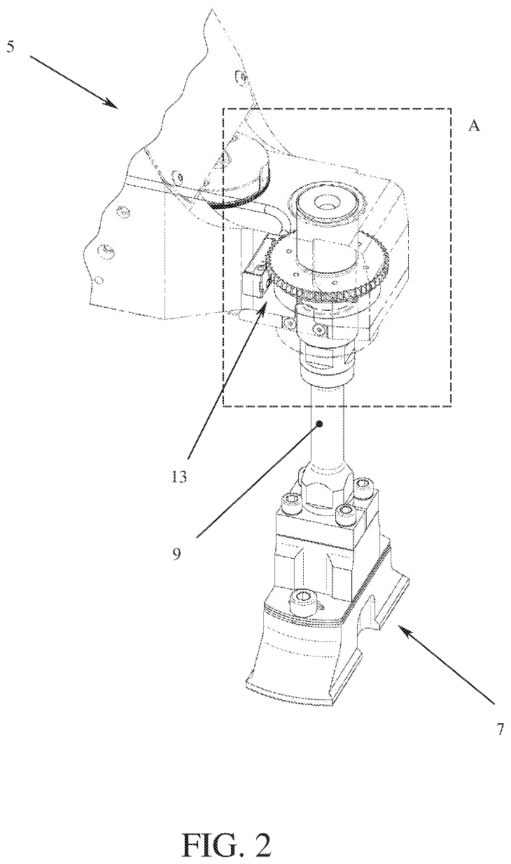

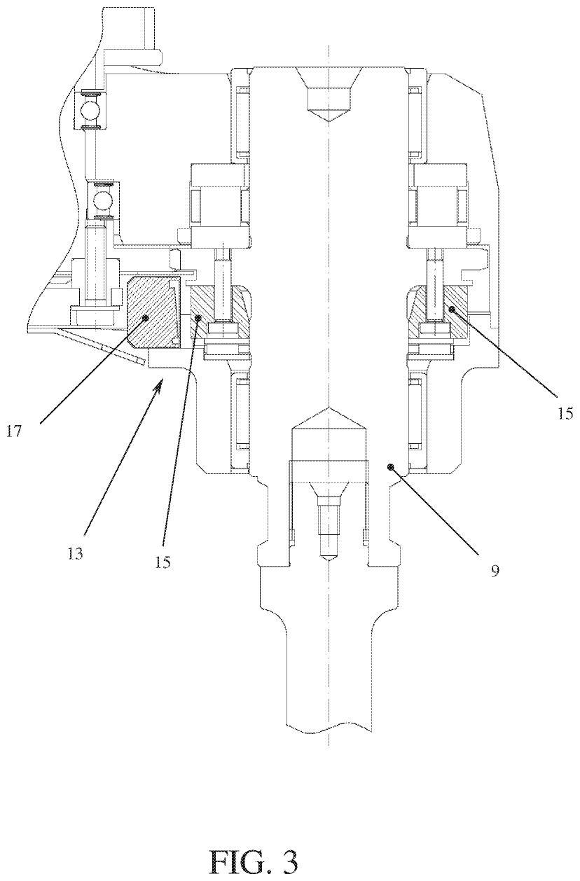

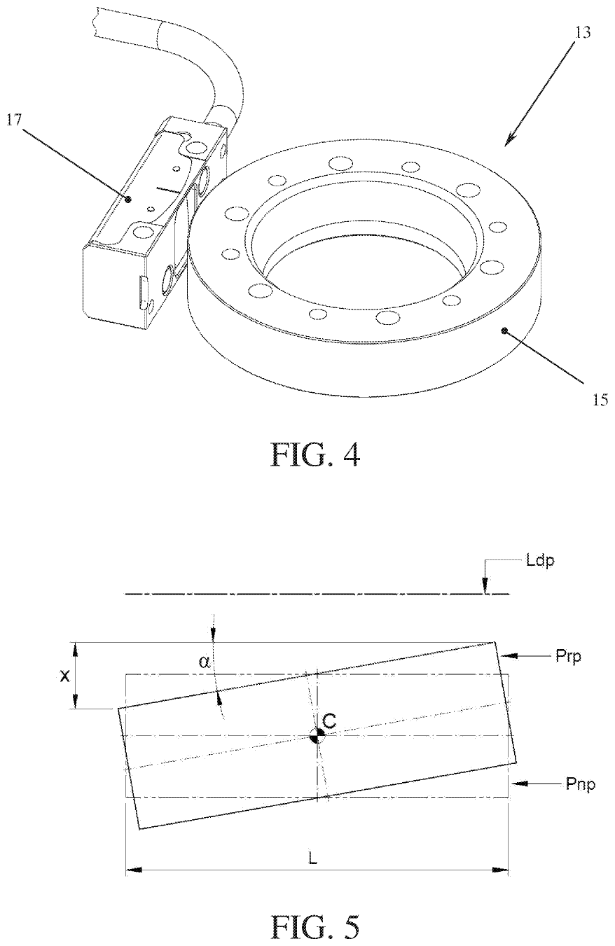

### DETAILED DESCRIPTION

With reference to the Figures, it is therefore possible to note a preferred embodiment of the paneling machine 1 including a workpiece rotation control system, this paneling machine 1 comprising at least one rotator device 3 and being served by at least one manipulator device 5 with gripper 7 on a rotating axis 9 provided to arrange in a predetermined position at least one workpiece of material to be processed (not shown), typically a sheet of metal, on at least one rotating element 11 of this rotator device 3: advantageously, this manipulator device 5 with gripper 7 comprises at least one first measuring means 13 of at least one angular position of the rotary axis 9 of the gripper 7 and the rotator device 3 comprises at least one second measuring means (not shown) of at least one angular position of the rotary element 11 of the rotator device 3, such system further comprising processing means provided for relatively comparing at least a value of at least one angular position measured by the first measuring means 13 with at least one value of at least one angular position measured by the second measuring means.

Again advantageously, the processing means operatively cooperate with the rotating element 11 of the rotator device 3 and/or the rotating axis 9 of the gripper 7 and, in the case in which the value of the angular position measured by the first measuring means differs from the value of the angular position measured by this second measuring means (i.e. a slippage of the workpiece with relative angular error with respect to its correct positioning has occurred, taking it from a position of the nominal workpiece Pnp to a position of the real workpiece Prp, as shown in particular in FIG. 5 and on which we will dwell later), these processing means command this rotating element 11 of the rotator device 3 and/or this rotating axis 9 of this gripper 7 to perform a rotation of the workpiece equal to the value of the angular difference (corresponding to the degrees and/or submultiples of the degree of slippage detected by the workpiece) between the value of the angular position measured by the first measuring means and the value of the angular position measured by the second measuring means.

In particular, the first measuring means 13 can be composed of at least one first rotary encoder device.

Similarly, the second measuring means can be composed of at least one second rotary encoder device.

Preferably, at least the first encoder device 13 is of the incremental optical type with high angular resolution: obviously, the first encoder device 13 can be of any other type suitable for the purpose, such as, for example, of the magnetic or inductive type of equal resolution, as well as of absolute type without departing from the scope of the present invention.

The first encoder device 13 can therefore comprise at least one respective graduated ring 15 integral with and coaxially arranged to the rotating axis 9 of the gripper 7 and a relative reading head 17 fixed with respect to the rotation of the rotating axis 9 and of the relative graduated ring 15.

For example, such a graduated ring can have a diameter of 52 mm with a graduation of 20 μm (corresponding to 8192 subdivision lines) and the relative reading head can be of the direct digital output type (with ×20 signal interpolator).

Preferably, the second encoder device is of the absolute optical type with high angular resolution: also in this case, the second encoder device could be of any other type suitable for the purpose, such as, for example, of the magnetic or inductive type of equal resolution, without departing from the scope of the present invention.

The second encoder device can therefore comprise at least one relative graduated ring integral with and arranged coaxially with the rotating axis (not shown) of the rotating element 11 of the rotating device 3 or on a rotating axis (not shown) rigidly connected thereto by means of a transmission and a relative reading head fixed with respect to the rotation of the rotating axis and of the relative graduated ring.

Therefore, the use of the two means for measuring the angular position, consisting for example of the two encoder devices, one arranged in the gripper 9 and one in the rotator device 3, makes it possible to apply a relative comparison between the relative positions (the measuring means of the device rotator 3 measures the rotation angle controlled by NC, that of the clamp 9 measures the effective rotation angle of the workpiece/sheet) providing the possibility of identifying any slippage of the workpiece: therefore, if both measuring means, and in particular, the encoder devices do not report the same position, it is possible to understand what the error is and correct it with an opposite rotation of the workpiece equal to degrees and/or submultiples of degree of slippage, without re-centering.

For example, with particular reference to FIG. 5, where:
L is the width of the workpiece measured in its nominal position Pnp: in the calculation example carried out below, L=2500 mm;
C is the center of rotation of the workpiece, corresponding to the center of rotation of the rotating element 11 of the rotator device 3 and of the gripper 7, between its nominal position Pnp and its real position Prp;
α is the angle of rotation of the workpiece corresponding to the slip from its nominal position Pnp to its real position Prp: in the calculation example carried out below, α=8.26 arcsec;
Ldp is the bending line, reference for centering the workpiece;
x is the linear error of rotation of the workpiece due to slippage, the angular accuracy of the system according to the present invention is equal to the minimum error of the angle measured by the encoder=±4.13 arcsec; that is, with minimum resolution of the workpiece angle=4.13×2=8.26 arcsec=0.002294 deg: therefore the linear error x=L is obtained·sinα=2500·sin (0.002294)=0, 1 mm.

The system according to the present invention therefore allows achieving the intended purposes as it allows:
accurately detecting and quantifying any slippage of the workpiece, for example of the sheet metal during the processing cycle by the paneling machine;
automatically correcting the angular error of the workpiece during the cycle;
automatically inserting a re-centering of the workpiece during the cycle;
reducing material waste;
reducing downtime;
reducing the cycle and setup time.

The present invention also relates to a paneling machine comprising at least one workpiece rotation control system such as the one described above.

1. A paneling machine including a workpiece rotation control system, the paneling machine comprising at least one rotator device and being served by at least one manipulator device with gripper on a rotating axis designed to arrange in a predetermined position at least one workpiece of material to be processed on at least one rotating element of the rotator device, the manipulator device with gripper comprising at least one first measuring means of at least an angular position of the rotary axis of the gripper,
wherein the rotator device comprises at least one second measuring means of at least one angular position of the rotating element of the rotator device, the system further comprising processing means designed for relatively comparing at least one value of at least one the angular position measured by the first measuring means with at least one value of at least one angular position measured by the second measuring means, the processing means being designed to operatively cooperate with the rotating element of the rotator device and/or the rotary axis of the gripper and, in the event that the value of the angular position measured by the first measuring means differs from the value of the angular position measured by the second measuring means, the processing means being designed to drive the rotating element of the rotator device and/or the rotary axis of the gripper to effect a rotation of the workpiece equal to a value of an angular difference between the value of the angular position measured by the first measuring means and the value of the said angular position measured by the second measuring means.

2. The paneling machine of claim 1, wherein the first measuring means are composed of at least one first rotary encoder device.

3. The paneling machine of claim 2, wherein the first encoder device is of the incremental optical type with high angular resolution.

4. The paneling machine of claim 2, wherein the first encoder device is of a magnetic or inductive and/or absolute type.

5. The paneling machine of claim 1, wherein the first encoder device comprises at least one respective graduated ring integral with and coaxially arranged to the rotating axis of the gripper and a relative reading head fixed with respect to the rotation of the rotary axis and of the relative graduated ring.

6. The paneling machine of claim 1, wherein the second measuring means is composed of at least one second rotary encoder device.

7. The paneling machine of claim 6, wherein the second encoder device is of the absolute optical type with high angular resolution.

8. The paneling machine of claim 6, wherein the second encoder device is of a magnetic or inductive type.

9. The paneling machine of claim 8, wherein the second encoder device comprises at least one relative graduated ring integral with and coaxially arranged to a rotating axis of the rotating element of the rotating device or a rigidly connected rotating axis to this by means of a transmission and a relative reading head fixed with respect to a rotation of the rotary axis and of said relative graduated ring.

10-11. (canceled)
